(19) United States
(12) Patent Application Publication
(10) Pub. No.: US 2018/0286190 A1
(43) Pub. Date: Oct. 4, 2018

(54) HAPTIC DEVICES

(71) Applicant: WOODEN EAR COMPANY, LLC, Sandy, UT (US)

(72) Inventors: David C. Fairbourn, Sandy, UT (US); Paul Walker, Dunholme (GB); Orlin Wetzker, Ogden, UT (US)

(21) Appl. No.: 15/849,857

(22) Filed: Dec. 21, 2017

Related U.S. Application Data
(60) Provisional application No. 62/477,627, filed on Mar. 28, 2017.

(51) Int. Cl. G08B 6/00; A47C 7/72; A47C 5/00; A63F 13/285; A63F 13/215

(52) U.S. Cl. CPC G08B 6/00; A47C 7/72; A63F 13/215; A63F 13/285; A47C 5/00

(57) ABSTRACT

Haptic devices that include a transducer configured to convert digital signals representing sound into sensory stimulation and methods of representing sound through sensory stimulation. An audio signal is received and a processed signal is generated from the audio signal that is indicative of a specific frequency in the audio signal. The processed signal is converted into a vibration stream used for sensory stimulation.

### TECHNICAL FIELD

The invention generally relates to haptic devices, and in particular to haptic devices that include a transducer configured to convert audio signals representing sound into sensory stimulation and methods of representing sound through sensory stimulation.

### BACKGROUND

Multimedia equipment and systems typically provide audible and visible information to a user. In addition to audible and visible information, multimedia systems may also introduce other sensory stimuli as well. For example, many video games provide tactile stimulation in addition to generating video graphics and sound. In particular, some video games include tactile feedback, which is usually transmitted through a video game controller to a user. As video games become more sophisticated and realistic, there is an increasing need to provide additional sensory features that may improve the user's overall gaming experience.

In addition to enhancing a user's overall experience with multimedia equipment, there is also a need to provide audio-based haptic stimulation to individuals, such as individuals who are hearing-impaired. A hearing-impaired individual may refer to a person whose primary mode of accessing sound does not involve hearing noise through his or her ear canal and with their auditory nerve. In at least some instances, a partially deaf individual may also be categorized as hearing-impaired as well, and the categorization depends on the level of the individual's hearing loss. Hearing-impaired individuals may still be able to receive sounds, such as music, using one of their other senses.

Improved methods and products to provide sensory stimulation, such as haptic stimulation, are needed.

### SUMMARY

In an embodiment, a haptic device includes at least one processor configured to receive an audio signal and generate a processed signal indicative of a specific frequency in the audio signal, and at least one transducer in communication with the at least one processor. The at least one transducer are the at least one processor are configured to convert the processed signal into a vibration stream used for sensory stimulation.

In an embodiment, a method includes receiving, by at least one processor, an audio signal from a sound source, generating a processed signal indicative of a specific frequency in the audio signal, converting the processed signal into a vibration stream, and vibrating an object using the vibration stream.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is an exemplary perspective view of the disclosed haptic device, where the haptic device is illustrated as a chair.

FIG. 2 is an exploded view of the chair shown in FIG. 1.

FIG. 3 is a rear view of the chair shown in FIG. 1, where a plurality of transducers are located upon back slats of the chair.

FIG. 4 is a schematic diagram of an electronics module of the chair illustrated in FIG. 1 in communication with the transducers shown in FIG. 3.

FIG. 4A is a perspective view of an article of clothing serving as a haptic device carrying the transducers.

FIG. 5 is a diagrammatic view of an exemplary computer system.

### DETAILED DESCRIPTION

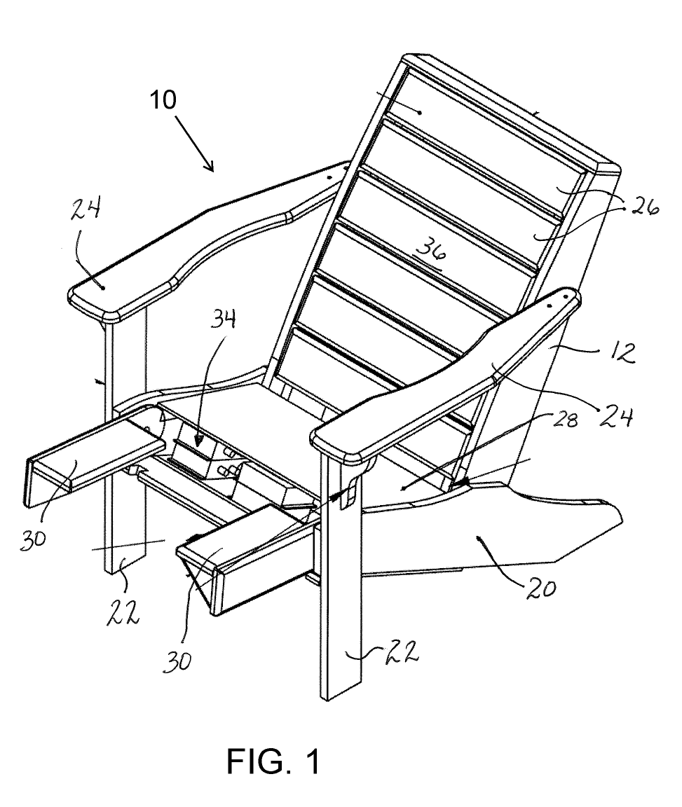

With reference to FIGS. 1-3 and in accordance with embodiments of the invention, a haptic device 10 in accordance with an embodiment of the invention is illustrated. In the exemplary embodiment as shown in the figures, the haptic device 10 is illustrated as a chair 12. As explained in greater detail below, although the figures illustrate a chair, the haptic device 10 is not limited to a chair or even to a specific piece of furniture. The chair 12 may include a pair of opposing side members 20 (only one side member is visible in FIG. 1), a pair of opposing legs 22, a pair of opposing arms 24, one or more back slats 26, a bottom slat 28, a pair of calf rests 30, and an electronics console or module 34. The back slats 26 define a surface 36 for a user to rest his or her back against. In the exemplary embodiment as shown, the chair 12 includes six back slats 26, however it is to be appreciated that this illustration is merely exemplary in nature and any number of back slats 26 may be used.

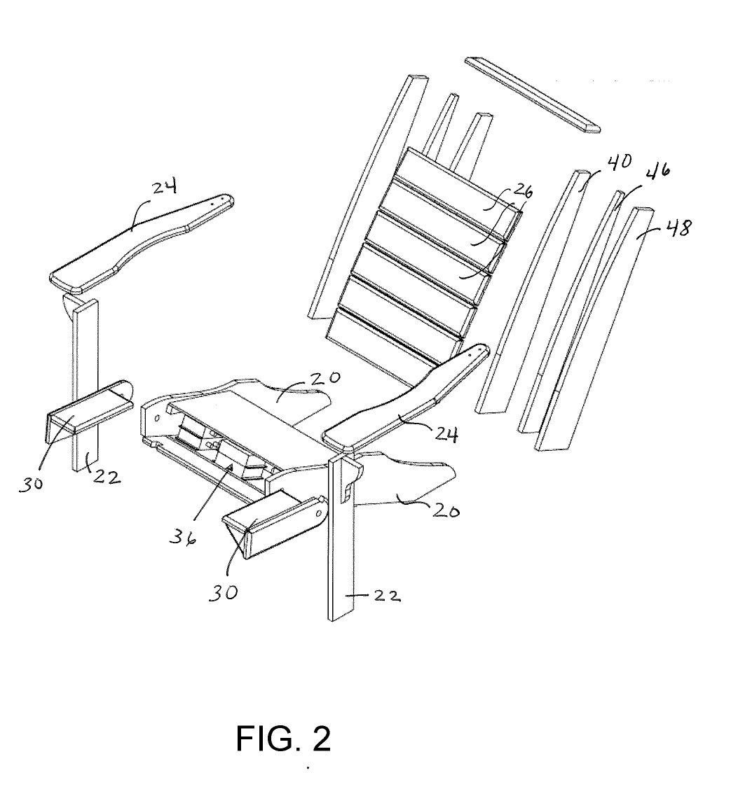

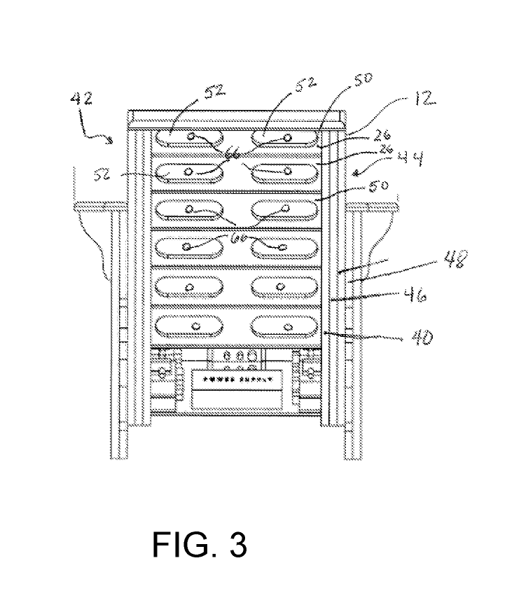

FIG. 2 is an exploded view of the chair 12, and FIG. 3 is a rear view of the chair 12. Referring to FIG. 3, a pair of inner back struts 40 may be located on opposing sides 42, 44 of the chair 12, and are used to secure the back slats 26. The chair 12 may also include a pair of middle back struts 46 and a pair of outer back struts 48, where the middle back struts 46 are each located in between a corresponding inner back strut 40 and a corresponding outer back strut 48. Referring to FIGS. 1 and 2, the calf rests 30 may each be rotatably connected to a corresponding side member 20 of the chair 12.

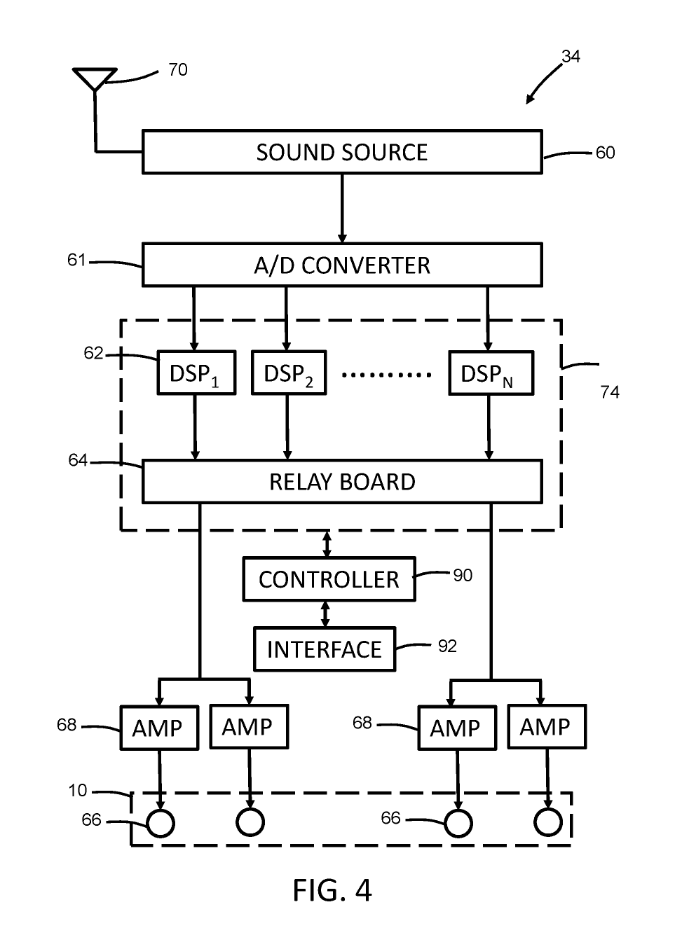

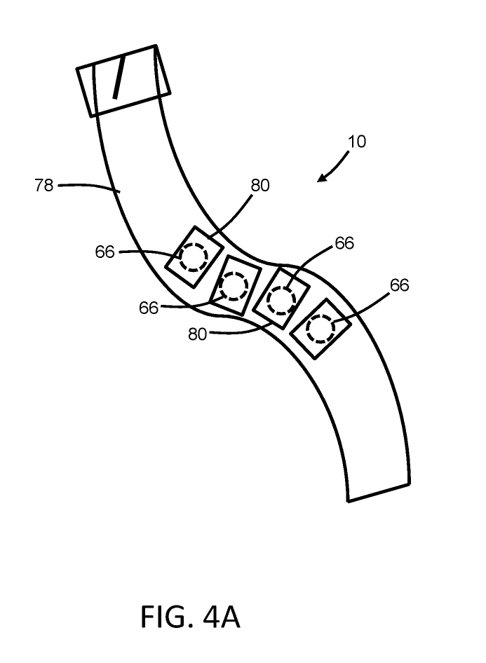

Referring to FIG. 3, a plurality of transducers 66 are situated in strategic locations upon the chair 12. As seen in FIG. 4, the transducers 66 are in communication with the electronics module 34. The transducers 66 may be any device configured to convert analog electrical signals into vibration, such as a dynamic moving-coil microphone sound transducer. Turning back to FIG. 3, transducers 66 are situated along a rear surface 50 of each back slat 26 of the chair 12. Specifically, each back slat 26 includes an area 52 where the thickness of the back slat 26 has been reduced. A single transducer 66 may be placed within each area 52 of the back slats 26. The area 52 of the back slat 26 includes an oval-shaped profile, however it is to be understood that the area 52 may be shaped into any number of other profiles as well.

The area 52 represents a portion of a corresponding back slat 26 that is reduced in thickness in order to more effectively transmit vibrations created by a corresponding transducer 66. Although only the back slats 26 are illustrated as including transducers placed within areas of reduced thickness in order to more effectively transmit vibration, it is to be appreciated that transducers may also be placed upon other components of the chair 12 as well. Moreover, other components of the chair 12 may also include areas of reduced thickness to more effectively transmit vibration as well. For example, an underside of each arm 24, which is not visible in the figures, may also include a transducer placed within an area of reduced thickness. Furthermore, the underside of the bottom slat 28, which is not visible in the figures, may also include one or more transducers placed within an area of reduced thickness as well. Although FIG. 3 illustrates the chair 12 as having the areas 52 of reduced thickness, it is to be appreciated that in another embodiment the areas 52 may be omitted.

The chair 12 defines a main body, which includes the side members 20, the legs 22, the arms 24, the back slats 26, the bottom slat 28, the calf rests 30, the back struts 40, the middle back struts 46, and the outer back struts 48. The main body of the chair 12 is constructed of one or more materials sufficiently flexible to transmit the vibrational forces generated by the transducers 66. For example, in one embodiment the main body of the chair 12 may be constructed of wood, such as American Cherry, Sapele, or a combination thereof. In another embodiment, the main body of the chair 12 may be constructed of plastic such as, for example, polyvinyl chloride (PVC). Although the figures illustrate the chair 12 as an Adirondack style chair, the chair 12 may include various other styles or configurations as well. For example, the chair 12 may be configured as a folding chair, a stadium chair, or a video gaming rocking chair.

As mentioned above, although the figures illustrate the haptic device 10 as a chair, it is to be appreciated that the haptic device 10 is not limited to a chair, or even to a specific piece of furniture. Instead, the haptic device 10 may be any type of object that a user may either wear, secure to his or her body, or rest his or her body upon. In one embodiment, the haptic device 10 may be a piece of furniture such as, for example, a bench.

In another embodiment and with reference to FIG. 4A, the haptic device 10 may be a piece or article of clothing, or other item, that is wearable by a user such as, but not limited to, a vest, a wearable pad, or belt. In the illustrated embodiment, the haptic device 10 may be a belt 78 having multiple pockets 80. Each of the pockets 80 may contain one or more transducers 66. In an embodiment, the pockets 80 may be formed by sewing, or otherwise joining, a strip of an elastic expandable material along the length of the belt 78, which operates as the main body of the haptic device 10. Wiring connects the transducers 66 with the electronics module 34. For example, the belt 78 may have twenty (20) transducers 66 and a pair of wires per transducer 66 that lead to a single pin connector for connection with the electronics module 34. The use of a complementary pin connector for the wiring leading to the electronics module 34 may promote interchangeability among different end devices (i.e., different haptic devices 10).

FIG. 4 is a schematic illustration of the electronics module 34 shown in FIG. 1 in communication with the transducers 66. Referring to FIGS. 1 and 4, the electronics module 34 may refer to, or be part of, an application specific integrated circuit (ASIC), an electronic circuit, a combinational logic circuit, a field programmable gate array (FPGA), a processor (shared, dedicated, or group) that executes code, or a combination of some or all of the above, such as in a system-on-chip. The electronics module 34 includes a sound source 60, an analog-to-digital (A/D) converter 61, a plurality of digital signal processors (DSPs) 62, a relay board 64, and a plurality of amplifiers 68.

In one embodiment, the sound source 60 may be a device that plays files that are stored on a data storage device to generate audio signals. For example, the sound source may be a compact disk (CD) player that plays CDs. In another embodiment, the sound source 60 may be a device that wirelessly connects to another electronic device to stream the audio signals. For example, in one approach the sound source 60 may include an antenna element 70 configured to receive a short-range RF signal such as, for example, a BLUETOOTH® signal conforming to the Institute of Electrical and Electronics Engineers (IEEE) Standard 802.15. The wireless signal may be sent from an electronic device such as, for example, a smartphone, a laptop computer, a gaming console, an MP3 player, or a tablet computer.

The sound source 60 may be capable of transforming the audio signals into electric analog signals. The audio signals are in the audible range of hearing for a human, which range from about 4.09 Hertz (Hz) to about 20,000 Hz. The audio signal represents a specific frequency of audible sound. The frequency may be part of a musical composition, or representative of a noise heard when playing video games. For example, the frequency could represent the noise heard when a user fires a gun while playing the video game. The analog signal generated by the sound source 60 is an electric signal that is representative of the frequency of the audio signal. The analog signal generated by the sound source is sent to the A/D converter 61. The A/D converter 61 converts the analog signal into a corresponding digital signal.

The A/D converter 61 may then send the digital signal to the DSPs 62. In the embodiment as shown in FIG. 4, the electronics module 34 includes N DSPs 62, where N represents any number. The DSPs 62 are used to convert the signal from the sound source 60 into a format that indicates various characteristics of the sound pattern, such as a pitch of a musical note as well as the frequency or amplitude of the note. In one non-limiting embodiment, the DSPs 62 may convert the digital signal from the sound source 60 into a signal that is compatible with the Musical Instrument Digital Interface (MIDI) protocol. One commercially available example of a DSP device that may be used is the C6713 SigmaDSP® audio processor, which is available from Analog Devices of Norwood, Mass. Another commercially available example of a DSP device that may be used is the miniDSP 2×4 kit, which is available from miniDSP of Kowloon, Hong Kong. After the conversion, the DSPs 62 include a digital-to-analog converter that converts the processed digital signals back to analog signals, which are provided through the relay board 64 to the amplifiers 68.

In the embodiment as shown in FIG. 4, the DSPs 62 are all located upon a single printed circuit board (PCB) 74. As explained below, it may be easier to re-assign frequencies to the transducers 66 if the DSPs 62 are all placed upon the same PCB 74. However, although FIG. 4 illustrates the DSPs 62 on the same PCB 74, in another embodiment the DSPs 62 may be single units as well. Each DSP 62 may be in communication with the relay board 64 and one or more amplifiers 68. The relay board 64 may be used to introduce other frequencies to the system that are not representative of sound. For example, the relay board 64 may be able to introduce frequencies such as touch or smell.

In the embodiment as illustrated, the DSP 62 is in communication with a pair of amplifiers 68, however it is to be appreciated that this illustration is exemplary in nature. Each amplifier 68 is in communication with a corresponding transducer 66. The transducers 66 convert the incoming signal at a specific frequency from a particular amplifier 68 into a vibration. The vibration generated by the transducer 66 vibrates at the specific frequency indicated by the received signal. In one embodiment, the signal from the amplifier 68 may be representative of a musical note. For example, in one exemplary approach, the received signal indicates a specific frequency of middle C, which has a frequency of about 261.6 Hz. Accordingly, the transducer 66 generates a vibration or tactile stimulation that vibrates at a frequency which corresponds to the specific frequency indicated by the signal. In the present example, the transducer would vibrate at a frequency of about 261.6 Hz.

The note middle C played on one specific musical instrument will not sound the same as the same note played on another musical instrument. For example, middle C played on a trumpet does not sound the same as middle C played on a piano. This is because both instruments not only play the predominant frequency middle C, but also have unique side band frequencies which create the particular sound of a specific instrument. The side band frequencies include a lower amplitude than the predominant frequency. The side band frequencies are conveyed to an individual using one or more transducers 66 that are different from the transducer 66 conveying the predominant frequency.

Referring to both FIGS. 3 and 4, the vibration created by a specific one of the transducers 66 is transmitted to a specific portion of the main body of the chair 12. In the present example, if the transducer 66 is located on the uppermost back slat 26, on the left hand side, then the transducer 66 vibrates at a frequency of about 261.6 Hz. The vibration generated by the transducer 66 is transmitted to the main body of the chair 12. More specifically, the vibration generated by the specific transducer 66, which includes a frequency of about 261.6 Hz, is transmitted to the uppermost back slat 26 of the chair 12.

Referring to FIGS. 1 and 3, when an individual is seated on the chair 12, then he or she may experience the vibration generated by the specific transducer 66, which is transmitted through a portion of the chair 12. In the present example, when the transducer 66 is located on the uppermost back slat 26 of the chair on the left hand side, then the user feels the vibration on the upper part of his or her back. In particular, the user experiences a tactile stimulation of the musical note middle C, since the transducer 66 produces a vibration having a frequency of about 261.6 Hz. Although the present example describes the transducer 66 located on the left hand side of the uppermost back slat 26 vibrating at a frequency equivalent to middle C, in one embodiment the user may customize the chair 12 such that the vibration may be produced at other portions of the chair 12 as well.

Referring now to both FIGS. 1 and 4, in one embodiment the user may be able to customize the chair 12 based on his or her preferences so as to disperse different frequencies across their body. Specifically, a user may be able to choose where on the body that vibration at a particular frequency may be created and thereby sensed. As seen in FIG. 4, in one embodiment the chair 12 may be equipped with a controller 90 having a user interface 92. The controller 90 is in communication with the DSPs 62, and allows for a user to customize the particular frequency that each transducer 66 is correlated to. For example, the transducer 66 located on the uppermost back slat 26 of the chair on the left hand side correlates to middle C. However, a user may wish to feel the vibration corresponding to middle C on another portion of his or her body. The user may wish to feel the note middle C on one of his legs or arms. Accordingly, the user may enter a new configuration into the controller 90 by the user interface 92 to indicate that he would like to feel the vibration corresponding to middle C on another portion of his body. For example, the user may indicate that he would like to feel the vibration corresponding to middle C on his left calf. Accordingly, the transducer located on the left calf rest 30 may now vibrate at a frequency of about about 261.6 Hz, which correlates to middle C.

Referring generally to FIGS. 1-4, the disclosed haptic device 10 represents a vibration transfer device that provides tactile simulation corresponding to audible sounds, such as the frequencies and rhythms of audible sounds and the sound intensity, to a person. In one approach, the haptic device 10 may be used in conjunction with multimedia equipment such as, for example, video games. For example, the haptic device 10 may be used as a gamer's chair. In this approach, the haptic device 10 may enhance a gamer's overall experience by providing tactile stimulation based on audio generated by the video game. For example, the tactile stimulation may be synchronized with the heard sounds and displayed images of the video game. In another embodiment, the haptic device may be used to allow for hearing-impaired individuals to feel sounds such as music based on tactile stimulation. Generally, audio signals (or waves) may be converted to vibrations and transmitted through the sensory (skin) nervous system by translating digital audio into the sensory (skin) system using a variety of techniques and distributing the audio signals in real-time as vibrations across a person's body. Audio files may be translated into vibrations that can be felt but not necessarily heard, and that represent frequencies and rhythms that the sensory (skin) nervous system can distinguish.

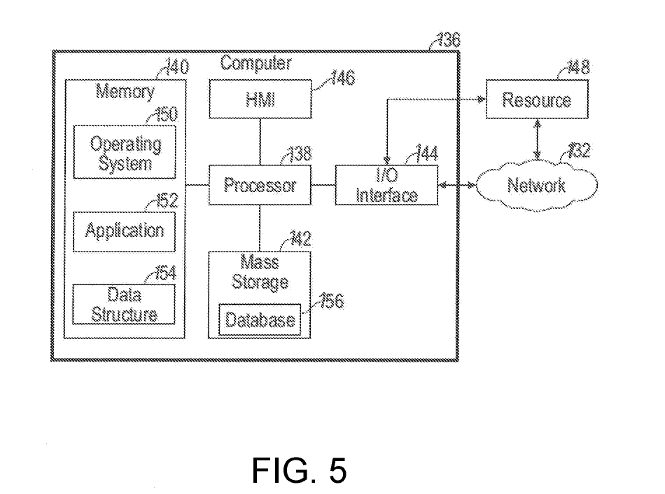

Referring now to FIG. 5, the DSPs 62 and the controller 90 of the electronics module 34 may be implemented on one or more computer devices or systems, such as exemplary computer system 136. The computer system 136 may include a processor 138, a memory 140, a mass storage memory device 142, an input/output (I/O) interface 144, and a Human Machine Interface (HMI) 146. The computer system 136 may also be operatively coupled to one or more external resources 148 via the network 132 or I/O interface 144. External resources may include, but are not limited to, servers, databases, mass storage devices, peripheral devices, cloud-based network services, or any other suitable computer resource that may be used by the computer system 136.

The processor 138 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 140. Memory 140 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing information. The mass storage memory device 146 may include data storage devices such as a hard drive, optical drive, tape drive, volatile or non-volatile solid state device, or any other device capable of storing information.

The processor 138 may operate under the control of an operating system 150 that resides in memory 140. The operating system 150 may manage computer resources so that computer program code embodied as one or more computer software applications, such as an application 152 residing in memory 140, may have instructions executed by the processor 138. In an alternative embodiment, the processor 138 may execute the application 152 directly, in which case the operating system 150 may be omitted. One or more data structures 154 may also reside in memory 140, and may be used by the processor 138, operating system 150, or application 152 to store or manipulate data, such as the digitized audio signals and the processed audio signals.

The I/O interface 144 may provide a machine interface that operatively couples the processor 138 to other devices and systems, such as the network 132 or external resource 148. The application 152 may thereby work cooperatively with the network 132 or external resource 148 by communicating via the I/O interface 144 to provide the various features, functions, applications, processes, or modules comprising embodiments of the invention. The application 152 may also have program code that is executed by one or more external resources 148, or otherwise rely on functions or signals provided by other system or network components external to the computer system 136. Indeed, given the nearly endless hardware and software configurations possible, persons having ordinary skill in the art will understand that embodiments of the invention may include applications that are located externally to the computer system 136, distributed among multiple computers or other external resources 148, or provided by computing resources (hardware and software) that are provided as a service over the network 132, such as a cloud computing service.

The HMI 146 may be operatively coupled to the processor 138 of computer system 136 in a known manner to allow a user to interact directly with the computer system 136. The HMI 146 may include video or alphanumeric displays, a touch screen, a speaker, and any other suitable audio and visual indicators capable of providing data to the user. The HMI 146 may also include input devices and controls such as an alphanumeric keyboard, a pointing device, keypads, pushbuttons, control knobs, microphones, etc., capable of accepting commands or input from the user and transmitting the entered input to the processor 138.

A database 156 may reside on the mass storage memory device 142, and may be used to collect and organize data used by the various systems and modules described herein. The database 156 may include data and supporting data structures that store and organize the data. In particular, the database 156 may be arranged with any database organization or structure including, but not limited to, a relational database, a hierarchical database, a network database, or combinations thereof. A database management system in the form of a computer software application executing as instructions on the processor 138 may be used to access the information or data stored in records of the database 156 in response to a query, where a query may be dynamically determined and executed by the operating system 150, other applications 152, or one or more modules.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within that it is implemented in specific embodiments of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include random-access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatus, or other devices to function in a particular manner, such that the instructions stored in the computer-readable medium produce an article of manufacture including instructions that implement the functions, acts, and/or operations specified in the flow charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow charts, sequence diagrams, and/or block diagrams.

In certain alternative embodiments, the functions, acts, and/or operations specified in the flow charts, sequence diagrams, and/or block diagrams may be re-ordered, processed serially, and/or processed concurrently consistent with embodiments of the invention. Moreover, any of the flow charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A haptic device comprising:
at least one processor configured to receive an audio signal and generate a first processed signal indicative of a first frequency in the audio signal; and
a first transducer in communication with the at least one processor,
wherein the at least one processor and the first transducer are configured to convert the first processed signal into a first vibration stream used for sensory stimulation.

2. The haptic device of claim 1 further comprising:
a main body to which the first transducer is attached,
wherein the first transducer transmits the first vibration stream to the skin of the person.

3. The haptic device of claim 2 wherein the main body is a chair, and the first vibration is transmitted from the first transducer to the skin of the person through a portion of the chair.

4. The haptic device of claim 3 wherein the chair is constructed from wood.

5. The haptic device of claim 4 wherein the wood is American Cherry, Sapele, or a combination thereof.

6. The haptic device of claim 2 wherein the main body is an article of clothing.

7. The haptic device of claim 6 wherein the article of clothing is a belt.

8. The haptic device of claim 1 wherein the at least one processor is configured to generate a second processed signal indicative of a second frequency in the audio signal, and further comprising:
a second transducer in communication with the at least one processor,
wherein the at least one processor and the second transducer are configured to convert the second processed signal into a second vibration stream used for sensory stimulation.

9. The haptic device of claim 8 further comprising:
a main body to which the first transducer and the second transducer are attached,
wherein the first transducer is arranged relative to the main body to transmit the first vibration stream to the skin of the person over a first area, and the second transducer is arranged relative to the main body to transmit the second vibration to the skin of the person over a second area.

10. The haptic device of claim 1 further comprising:
a sound source configured to produce the audio signal, the sound source coupled with the at least one processor.

11. A method comprising:
receiving, by at least one processor, an audio signal;
generating a processed signal indicative of a specific frequency in the audio signal;
converting the processed signal into a vibration stream; and
vibrating an object using the vibration stream.

12. The method of claim 11 wherein the processed signal is converted into the vibration stream by at least one transducer, and vibrating the object further comprises:
transmitting the vibration stream from the at least one transducer to the skin of a person.

13. The method of claim 12 wherein the at least one transducer is attached to a main body, and vibrating the object further comprises:
transmitting the vibration stream through the main body to the skin of the person.

14. The method of claim 13 wherein the main body is a chair in which the person is sitting.

15. The method of claim 13 wherein the main body is an article of clothing that the person is wearing.

16. The method of claim 15 wherein the article of clothing is a belt being worn by the person.

17. The method of claim 11 wherein the audio signal is received from a sound source.
